(19) United States
(12) Patent Application Publication
(10) Pub. No.: US 2013/0091769 A1
(43) Pub. Date: Apr. 18, 2013

(54) AUTOMATED GLAZING ASSEMBLY

(71) Applicants: TIMOTHY MEDEMA, Everett, WA (US); Richard Mu, Everett, WA (US); Xiaojun Qin, Yangzhou (CN); Jianhui Yan, Shenzhen (CN)

(72) Inventors: TIMOTHY MEDEMA, Everett, WA (US); Richard Mu, Everett, WA (US); Xiaojun Qin, Yangzhou (CN); Jianhui Yan, Shenzhen (CN)

(73) Assignee: Crystalite, Inc., Everett, WA (US)

(21) Appl. No.: 13/229,628

(22) Filed: Sep. 9, 2011

Related U.S. Application Data
(60) Provisional application No. 61/381,302, filed on Sep. 9, 2010.

(51) Int. Cl. E05F 15/20

(52) U.S. Cl. CPC E05F 15/2076; E05F 15/2007; E05F 15/20
USPC 49/25; 49/70; 49/506

(57) ABSTRACT

A system and method using a skylight panel within a skylight frame attached to a flexible actuator. In an embodiment, the system provides for automated opening and closing of a remotely located skylight or window. The system may also include a solar panel coupled to a rechargeable battery pack that provides power to an electric motor that controls the actuation of the actuator. Such control may be realized through a gear train with a sprocket wheel that drives a flexible chain-like actuator that is coupled to the skylight panel. The system may further include a control circuit for controlling the above-described operation wherein the control circuit is also operable to communicate with a remote control device having two-way communication between them.

### CLAIM OF PRIORITY

This application claims priority from U.S. Provisional Patent Application No. 61/381,302 entitled “AUTOMATED GLAZING ASSEMBLY” filed on Sep. 9, 2010, the entirety of which is incorporated herein by reference.

### BACKGROUND

Glazings, as commonly referenced in the industry, may refer to windows, skylights, doors with window panes or any other device that may use glass or similar substance to provide a means for ambient light to pass. Skylights may be used in residential and commercial buildings to provide ambient light to rooms as well as an option for opening one or more skylights to provide for ventilation and temperature control. By definition, a skylight (as opposed to simply a window) is located at the ceiling of a room or, at the very least, high up on a wall in a typically inaccessible location. Thus, for installation, cleaning and repair, a person will typically need to use a ladder or scaffolding for access. Furthermore, some skylights are designed to be opened and closed to provide for the aforementioned ventilation and temperature control. As such, any manual opening or closing of the skylight may also require a ladder or extension pole for actuation. Because of the inaccessibility of skylights, an automated opening and closing actuation system would be desirable to eliminate the need for ladders and/or extension poles.

### BRIEF DESCRIPTION OF THE DRAWINGS

The foregoing aspects and many of the attendant advantages of the claims will become more readily appreciated as the same become better understood by reference to the following detailed description, when taken in conjunction with the accompanying drawings, wherein:

FIG. 1 shows a diagram of a skylight assembly according to an embodiment of the subject matter discussed herein.

FIG. 2 shows a more detailed view of an actuator that may be part of the skylight assembly of FIG. 1 according to an embodiment of the subject matter discussed herein.

### DETAILED DESCRIPTION

The following discussion is presented to enable a person skilled in the art to make and use the subject matter disclosed herein. The general principles described herein may be applied to embodiments and applications other than those detailed above without departing from the spirit and scope of the present detailed description. The present disclosure is not intended to be limited to the embodiments shown, but is to be accorded the widest scope consistent with the principles and features disclosed or suggested herein.

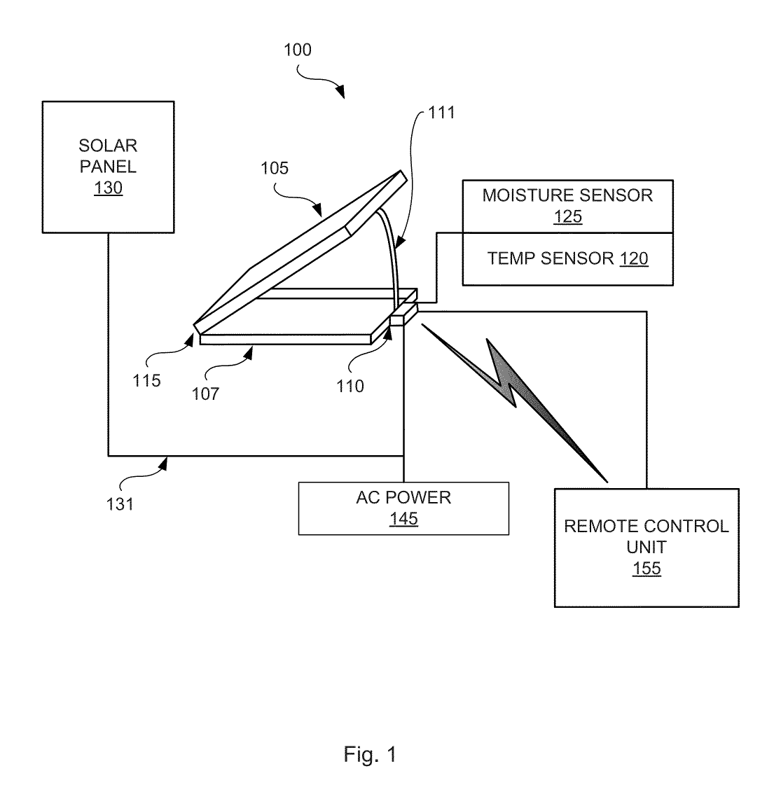

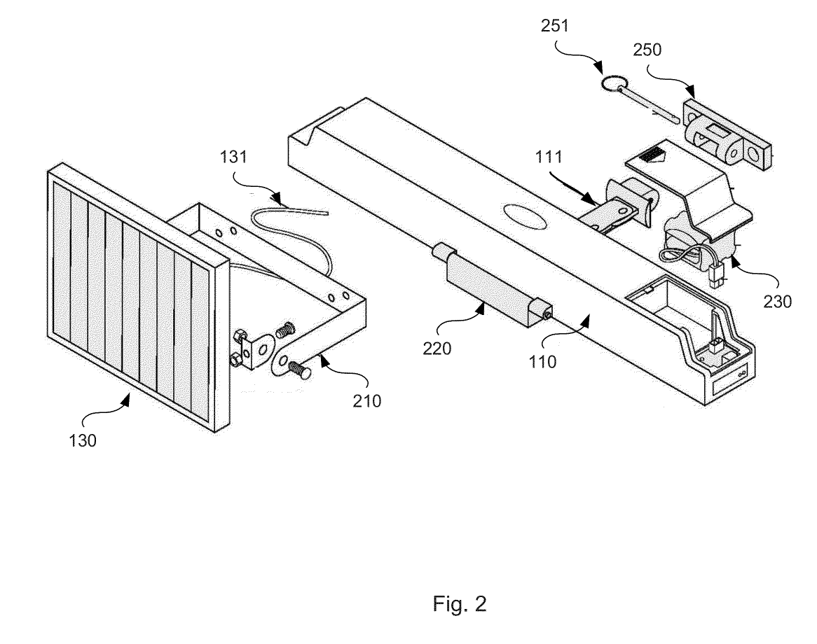

As an overview, a system according to an embodiment of the subject matter discussed herein may include a skylight panel (e.g., a glazing) within a skylight frame attached to an actuator. Further, the system may include a solar panel coupled to a rechargeable battery pack that provides power to an electric motor that controls the actuation of the actuator. Such control may be realized through a gear train with a sprocket wheel that drives a chain-like actuator that is coupled to the skylight panel. The system may further include a control circuit for controlling the above-described operation wherein the control circuit is also operable to communicate with a remote control device having two-way communication between them. As is commonly understood in the industry, these and other concepts discussed below apply equally well to any glazing, such as windows and doors with glazings. These and other aspects are discussed in greater detail below with respect to FIGS. 1 and 2.

FIG. 1 is a diagram of an automated skylight system 100 according to an embodiment of the subject matter discussed herein. The system 100 includes a glazing 105 mounted with in a skylight frame 107. The glazing 105 may further include a glazing frame (not labeled in detail) around the glazing 105 that encompasses the ends of the glazing such that sharp or unfinished edges are not exposed. Glazings 105 in such systems may be made of glass, plastic or other suitable transparent or translucent material. Further, although described herein as a skylight system 100, those skilled in the art understand that the principles discussed herein apply equally to windows on walls as well as doors.

The glazing 105 and its frame may be rotatably attached to the frame 107 at one end (at attachment point 115) such that the glazing 105 may be rotated about this one end to an open position (as shown in FIG. 1) or a closed position. When in a closed position, the glazing 105 and the skylight frame 107 form a weather-resistant or water-tight seal such that elements of weather are prevented from entering the interior of a room in which the skylight assembly 100 is installed. Such a weather-resistant or water-tight seal is common for any typical skylight assembly 100.

The glazing 105 may be mechanically coupled to an actuator 110 that is designed to provide a means for opening and closing the skylight in an automated and motorized manner. The actuator 110 includes and actuator arm 111 that is attached to an end of the glazing 105. In the embodiment shown in FIG. 1, this end of the glazing 105 is an opposite side from the rotation attachment point 115 discussed above. In other embodiments not shown, the actuator 110 and actuator arm 111 may be attached to the frame and glazing at other locations. The actuator 110 and actuator arm 111 are operable to move the glazing 105 between an open position and a fully-closed position.

In this embodiment as shown in FIG. 1, the system 100 includes a rechargeable battery (not shown in FIG. 1, but shown in FIG. 2) for providing electrical power to the actuator 110. The power for actuating the system 100 may be provided solely by the battery or may draw power from an AC power source 145 electrically coupled to the system 100. Further, the AC power source 145 may be used to recharge the battery.

However, often times in retrofit applications, an AC power source 145 is not readily available. Thus, in some embodiments, the system includes a solar panel 130 for providing power to the system and for recharging the battery. Having the actuator 110 operate with electrical power provided via a rechargeable battery pack which may be recharged from solar energy derived from the solar panel 130 provides an automated skylight system 100 that does not need to have any additional electrical supply provided to it. The integral power source (e.g., rechargeable battery) eliminates AC wiring needed to skylight location(s) thereby making any retrofit installation simple and very affordable. Furthermore, a solar-powered rechargeable system 100 is energy-efficient and is self-contained providing for a skylight that may be considered environmentally friendly.

The system 100 may further include a remote control unit 155 that is operable to communicate with the actuator 110 at the skylight. Thus, simple commands may be initiated at the remote control unit 155, such as skylight-open and skylight close, whereby the actuator maneuvers the glazing 105 into an open position or a closed position, respectively. Additional control parameters may be implemented. One such parameter may be a partial opening signal wherein the glazing 105 is opened but not to a fully actuated position. Another control parameter may include a timed opening function wherein the glazing 105 may be opened and then closed after one hour of time.

The remote control unit 155 may include bi-directional communication with a transmitter/receiver that may be part of the actuator 110. Such communication may provide additional information for control use. Such information may include operator battery status, solar charging current to the operator battery pack, zone assignment or grouping of related skylights at any time, minimum and maximum travel in the opening direction and reprogramming of such parameters, and skylight opening or closing status. Further yet, the remote control unit 155 may act as a thermostat for measuring temperature in the room and controlling the skylight per the user set points. The remote control unit 155 may also be operable to provide control based on the time of day, with at least two separate selectable program sequences.

The skylight assembly itself may include additional sensors for realizing additional control parameters. In an embodiment, a temperature sensor 120 may be used to control opening and closing the glazing 105. For example, the skylight may be opened if the ambient temperature in a room exceeds a threshold or the temperature outside exceeds a threshold. Further, in another embodiment, a moisture sensor 125 may be used to control opening and closing the glazing 105. For example, this control parameter may be used to implement a moisture-controlled closing wherein the moisture sensor 125 senses that it is raining outside and that the skylight needs to be closed to prevent water from getting inside.

FIG. 2 shows a more detailed view of an actuator 110 that may be part of the skylight assembly of FIG. 1 according to an embodiment of the subject matter discussed herein. In FIG. 2, a more detailed view of the solar panel 130 is shown. The solar panel 130 may be mountable on or near the skylight using a mounting bracket 210. Further, the solar panel may be electrically coupled to the actuator via power cable 131. Although not shown coupled, such a power cable 131 may be electrically coupled to the battery 230 to provide actuating and recharging power as discussed above.

The actuator 110 as shown in FIG. 2 includes a mounting bracket 220 that may be mechanically coupled to the skylight frame 107 (not shown in FIG. 2). Further, a more detailed view of the actuator arm 111 is shown in FIG. 2 along with a disengageable latch 250 that may be mechanically attached to one end of the glazing 105 (also not shown in FIG. 2) through a release pin 251.

In an embodiment as shown in FIG. 2, the skylight includes a flexible actuator arm 111 which may be extended and retracted by switching a motor (not shown, but within the actuator 110) on in a forward rotation (for extending) and/or a reverse rotation (for retracting). Because the skylight panel is rotatably attached at one end, when the glazing 105 is opened, the opposite end attached to the actuator arm 111 does not move within a plane. Rather, this end of the glazing 105 strikes an arc when moving to the open position. Therefore, the actuator arm 111 may be flexible (e.g., non-rigid) such that as the glazing rotates open, the actuator arm 111 does not place too much torque on the motor that is driving the actuator arm to its extended position.

To further alleviate torque on the motor, the actuator arm 111 may by attached to the skylight frame 107 in a rotatable manner. Thus, the mount 220 of the actuator 110 coupled to the frame 107 may pivot, allowing the actuator arm 111 to stay perpendicular to the glazing 105 during operation. By maintaining this perpendicular angle, the actuator motor uses less energy (typically saving 30-35%) because the angle does not change and cause additional torque on the motor. The changing angle may often lead to additional friction as the actuator arm 111 applies a lateral force on the motor attachment assembly.

The flexible actuator arm 111 may comprise a flexible drive chain. Such a flexible drive chain provides for a limited amount of “play” in lateral directions when the glazing 105 is being opened or closed. Such play helps reduce the friction as discussed above and thereby reduces the amount of additional energy consumed when higher frictional forces are encountered. This flexible drive chain can further trigger a position sensing limit switch through a mechanical pin attached to the flexible drive chain such that the motor may be stopped before the chain can be unseated from a sprocket wheel when reaching the end of its travel motion.

As different aspects of the actuation produce torque on the actuator motor, the system may include a current surge sensing circuit (also within the actuator 110 as shown in FIG. 2) that may interrupt the actuation control when a current surge is detected. A current surge may result from the motion of the glazing 105 being impeded by an exterior force. Thus, the motor attempts to maintain torque and the current drawn from the battery 230 to provide additional power results in a current surge. If the sensing circuit can detect such a current surge early, the actuator 110 may be stopped so as to prevent a power drain on the battery 230 and prevent damage to the motor and actuator Further yet, the actual torque level (and corresponding surge current) for interruption of the actuation may be a programmable feature such that a threshold may be set low to ensure no damage can occur or be set higher to allow for additional torque if small objects like leaves or branches may be slightly impeding the movement of the glazing 105. Such thresholds may be set to prevent damage to the skylight assembly itself and/or to protect objects that may be closed upon during actuation.

While the subject matter discussed herein is susceptible to various modifications and alternative constructions, certain illustrated embodiments thereof are shown in the drawings and have been described above in detail. It should be understood, however, that there is no intention to limit the claims to the specific forms disclosed, but on the contrary, the intention is to cover all modifications, alternative constructions, and equivalents falling within the spirit and scope of the claims.

What is claimed is:

1. An apparatus, comprising:
a glazing;
a frame for holding the glazing; and
an actuator for maneuvering the frame in response to an input signal.

2. The apparatus of claim 1, wherein the glazing further comprises glass.

3. The apparatus of claim 1, wherein the actuator comprises an actuation arm coupled between the glazing and the frame, the actuation arm configured to be extended to maneuver a portion of the glazing away from the frame.

4. The apparatus of claim 3, wherein the actuation arm comprises a flexible actuation arm.

5. The apparatus of claim 3, wherein the actuation arm comprises a non-rigid actuation arm.

6. The apparatus of claim 3, wherein the actuation arm comprises a plurality of linked drive chain members.

7. The apparatus of claim 1, further comprising a motor coupled to the actuator configured to produce the actuator maneuvering.

8. The apparatus of claim 1, wherein the maneuvering comprises moving a portion of the glazing away from the frame.

9. The apparatus of claim 1, wherein the maneuvering comprises moving a portion of the glazing toward from the frame

10. The apparatus of claim 1, wherein the maneuvering comprises moving a portion of the glazing away from the frame.

11. The apparatus of claim 1, wherein the input signal comprises a user input signal from a remote control circuit.

12. The apparatus of claim 1, wherein the input signal comprises a signal from a sensor that detects moisture.

13. The apparatus of claim 1, wherein the input signal comprises a signal from a sensor that detects temperature.

14. The apparatus of claim 1, wherein the input signal comprises a signal from a timer.

15. The apparatus of claim 1, further comprising:
a solar panel configured to generate power from ambient light; and
a battery coupled to the solar panel and configured to provide power to the actuator.

16. The apparatus of claim 15, further comprising a surge protection circuit operable to detect power drawn by the actuator beyond a threshold and configured to interrupt the power supplied to the actuator in response to exceeding the threshold.

17. A method, comprising:
receiving an input signal at a skylight having a maneuverable glazing; and
actuating a flexible drive arm to maneuver the glazing.

18. The method of claim 17, further comprising maneuvering the glazing to an open position.

19. The method of claim 17, further comprising maneuvering in response to an input signal comprising a signal from the group including: a timing signal, a temperature signal, a moisture signal, a power-failure signal, and a remote wireless signal.

20. The method of claim 17, further comprising detecting that the flexible drive arm reaches an actuated position and ceasing actuation in response to reaching the actuated position.

21. An apparatus, comprising:
an actuator having a flexible actuator arm configured to be coupled to a glazing and configured to produce a torque on the glazing about an axis of rotation;
a control circuit coupled to the actuator and configured to receive an input signal such that the actuator initiates a torque on the glazing in response to the input signal; and
a power supply coupled to the control circuit and coupled to the actuator configured to provide electrical power to drive the actuator.

23. The apparatus of claim 21, wherein the power supply comprises a rechargeable battery.

23. The apparatus of claim 21, wherein the power supply comprises a solar panel configured to generate electrical energy from ambient light.

24. The apparatus of claim 21, wherein the flexible actuator arm further comprises a flexible drive chain.

25. The apparatus of claim 21, further comprising a remote control circuit configured to be communicatively coupled with the control circuit and configured to generate the input signal.
